(19) United States
(12) Patent Application Publication
(10) Pub. No.: US 2008/0109406 A1
(43) Pub. Date: May 8, 2008

(54) INSTANT MESSAGE TAGGING

(76) Inventors: Santhana Krishnasamy, Foster City, CA (US); Wilson Lau, Redwood City, CA (US); Lionel Pelamourgues, Arcueil Cedex (FR)

Correspondence Address: THORNE & HALAJIAN;APPLIED TECHNOLOGY CENTER, 111 WEST MAIN STREET, BAY SHORE, NY, 11706, US

(21) Appl. No.: 11/556,892

(22) Filed: Nov. 6, 2006

(51) Int. Cl. G06F 15/16; G06F 7/10; G06F 17/30

(52) U.S. Cl. 707/3; 709/206; 707/E17.014

(57) ABSTRACT

A messaging system having a portion for receiving a message, a portion for associating a context tag with the message, and a portion for providing the message with the associated context tag if the message is transferred to a client during a messaging exchange. In one embodiment, the system may include a context provider for analyzing the massage and identifying the context tag. The context provider may identify a noun and/or verb contained within the message and provide the identified noun and/or verb as the context tag. The context tag may be provided automatically without user intervention or one or more context tags may be provided for selection by a user.

### FIELD OF THE PRESENT SYSTEM

The present system relates to an interface for an instant messaging system.

### BACKGROUND OF THE PRESENT SYSTEM

An instant message (IM) is a very popular system for communication between two or more parties. In a typical scenario, textual entries in a form of an intended correspondence portion is entered on a given device. After a given correspondence portion is composed, a send command is executed to transmit the correspondence portion from the given device to a device of an intended recipient. After accessing the correspondence portion, the recipient is provided an opportunity to reply to the correspondence portion. The correspondence portions may be displayed as separated strings of conversations. This system works well when there is only one pair of corresponding parties and one theme of message strings.

The current status of messaging technology (Instant Messaging, chat, forum, P2P applications, etc.) is very basic. When two users exchange messages on a given topic, a response to a message from one party to another may not be answered immediately and a given massage might be responded to only after messages that have a different topic have been received. In this case, it may be difficult for both the users to track where the conversation thread started and what conversation thread a given response corresponds to. Further, it may be difficult to search for one or more portions of a topic thread that transpires over a larger portion of time (e.g., days) and typically the only option available for searching is based on the identity of the participants and dates of topic thread portions.

U.S. Patent Publication No. 2005/235034, incorporated herein as if set out in its entirety, describes a system for Instant Message (IM) tagging wherein correspondence portions of an IM conversation thread may be stored in a centralized or distributed database. The conversation portions may be tagged, either manually be a given user or automatically by the system, with topic tags that identify one or more topics, including topic shifts of the conversation portions. The topic tags are saved as identifiers along with the IM conversation or conversation portions (threads) and may be utilized during a search of the conversation portions to retrieve conversation portions that correspond to the search. The topic tags work well for the party creating that tags to identify topics of an IM conversation as its occurring yet do nothing to help another party to the conversation identify current conversation threads since the topic tags are not shared between the parties as a portion of the conversation.

### SUMMARY OF THE PRESENT SYSTEM

It is an object of the present system to overcome disadvantages and/or make improvements in the prior art.

The present system includes a messaging system, such as an instant messaging system, having a portion for receiving a message, a portion for associating a context tag with the message, and a portion for providing the message with the associated context tag if the message is transferred to a client during a messaging exchange. In one embodiment, the system may include a context provider for analyzing the message and identifying the context tag. The context provider may identify a noun and/or verb contained within the message and provide the identified noun and/or verb as the context tag.

The context tag may be provided automatically without user intervention. In an alternate embodiment, one or more context tags may be provided for selection by a user. The system may identify a topic change within a message stream, identify a second context tag for a message corresponding to the topic change, and associate the second context tag with the identified message. The context tag and/or the second context tag may be provided as a prefix of the associated message during the messaging exchange.

The message and the associated context tag may be stored locally and/or remotely, for example at a messaging server. The message and associated context tag may be one of a plurality of stored messages and corresponding message tags. The system may enable receipt of a query of the messages and corresponding message tags. In response to a query, the query may be compared to the plurality of associated context tags. A message and associated context tag or a message stream and associated context tag may be retrieved in response to a result of the comparing.

The system may include one or more of a client and/or server for associating the context tag with the message. The system may be a portion of an instant messaging system. A user interface may be provided for operation of the system. For example, in one embodiment the user interface is provided as a portion of an instant messaging user interface. IN an alternate embodiment, the user interface is provided separate from the instant messaging user interface.

### BRIEF DESCRIPTION OF THE DRAWINGS

The present system is explained in further detail, and by way of example, with reference to the accompanying drawings wherein:

FIG. 1 shows an IM system in accordance with an embodiment of the present system;

FIG. 2 shows an illustrative flow diagram of operation in accordance with an embodiment of the present system;

FIG. 3 shows an illustrative display window of an instant messaging system in accordance with an embodiment of the present system; and

FIG. 4 shows a device in accordance with an embodiment of the present system.

### DETAILED DESCRIPTION OF THE PREFERRED EMBODIMENTS

The following are descriptions of illustrative embodiments that when taken in conjunction with the drawings will demonstrate the above noted features and advantages, as well as further ones. In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system. In addition, it should be expressly understood that the drawings are included for illustrative purposes and do not represent the scope of the present system.

In accordance with the present system, a run-time option is provided for users of an instant message (IM) client to add context to an IM portion. The IM portion may be all or a portion of a discussion, conversation, or simply a message. What is meant by the term context as utilized herein is that an identifier is provided that indicates one or more keywords that may serve to identify a given IM message and/or group of message (e.g., message transcript). To simplify the following discussion, a message will be discussed further herein and is intended to include a single transmission, one or portions of a transcript, such as a message thread, etc. that is intended to be transferred from one user to one or more users. In this sense, a message may be simply a single portion of a transcript or may identify a series of portions that are transferred between the users.

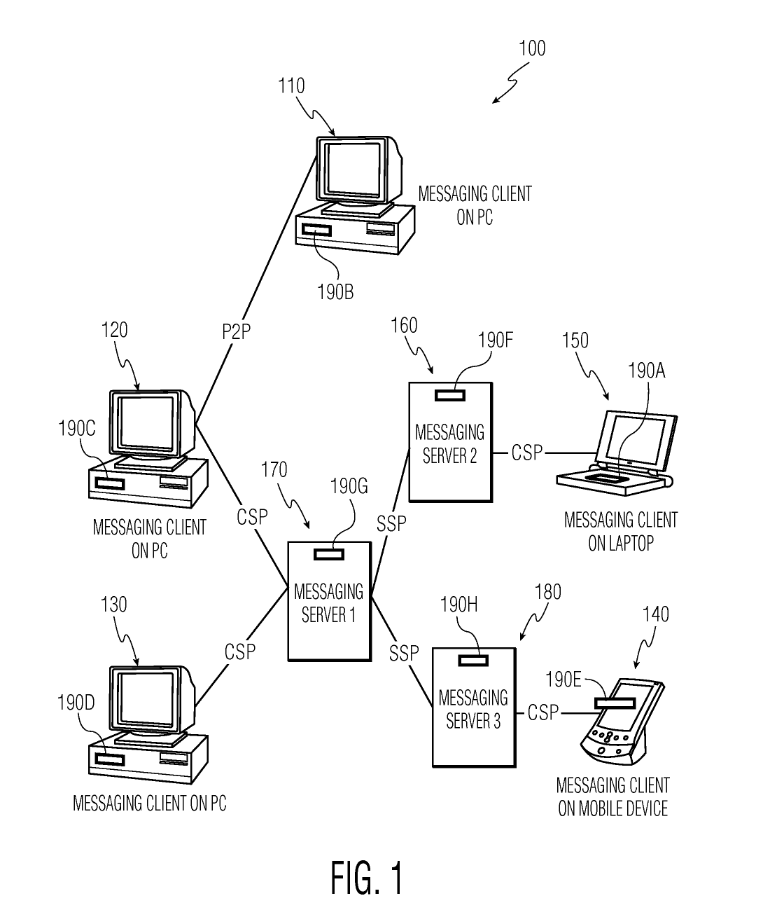

FIG. 1 shows an system 100, such as an IM system, in accordance with an embodiment of the present system. Illustratively, the system 100 includes several client systems including desktop based clients, such as desktop computing clients 110, 120, 130 and portable client based systems, such as portable laptop client 150 and portable palm sized computing system 140. These client systems, as may be readily appreciated by a person of ordinary skill in the art, are merely intended to illustrate and not to limit what may encompass a client system, such as an IM client system, short message service (SMS), and/or other messaging system that may include text, graphics, symbols and/or other identifiable communication. Other devices, including cell phone based devices may also be readily utilized in accordance with the present system. The client may be a dedicated device that solely operates as an messaging client or the client may be a multipurpose device, wherein operation in accordance with the present system is merely one of many (e.g., two or more) features that may be provided by the device.

The clients are operationally coupled together to enable a transfer of a message. The coupling between clients may be direct, such as indicated between clients 110, 120, or may be indirect such as indicated between clients 120, 140, wherein messaging servers 170, 180 act as intermediaries of the message. In accordance with a further embodiment, the coupling may include a client system acting as an intermediary that may also be a client system. For example, a message originating at client 110 may be intended to be forwarded to the client 150. In this illustrative embodiment, the client 120 may act as a server to forward the message to the client 150 via servers 170, 160 even in a case wherein a user of the client 120 is not an intended recipient of the message. Naturally, the user of the client 120 may also be an intended recipient in which case, the client 120 operates as both a client and server for this illustrative message. Further, configurations of clients and/or servers may be readily utilized in accordance with the present system.

The couplings between clients and servers may include a wired and/or wireless coupling that is managed utilizing one or more data transfer protocols. For example, a transfer protocol between client systems may include a peer-to-peer (P2P) coupling, as illustratively shown between clients 110, 120. The protocol between a client and server may be a client to server protocol. The protocol between servers may be a server to server protocol. The protocols that may be supported by the system 100 may include SIMPLE, XMPP, IMPS, MSN, Yahoo, AIM, Google, Skype and/or other messaging systems and protocols or combinations thereof. The particulars of the one of more protocols that serve to enable transfers of messages between members of the system 100 is beyond the scope of the present discussion. In any event, further communication protocols and/or combinations of protocols may be readily applied in accordance with the present system.

The context may be based on a subject of the message or group of messages and/or may even relate to an underlying topic that is not explicitly identified within the thread. The context may be provided either manually by a user or automatically by the system, for example as indicated in U.S. Patent Publication No. 2005/235034. In one embodiment in accordance with the present system, the context is automatically suggested by the system to a user based on noun and/or verb identification within the IM thread. In this embodiment, the system 100 may suggest a keyword based on one or more noun and/or verbs identified within the thread by the system 100. To facilitate this operation, a client station may be provided with a context identifier, such as context identifiers 190A, 190B, 190C, 190D, 190E. Further, similarly the servers may be provided with a context identifier, such as context identifiers 190F, 190G, 190H. Naturally not all of the context identifiers shown in FIG. 1 are required for operation in accordance with the present system. For example, in one embodiment in accordance with the present system, one or more context identifiers may reside at a client for providing context as described herein. In a case wherein the client with the context identifier originates a message, context may be provided to the message. In a case wherein the client with the context identifier receives a message with or without context, the client may add and/or edit the context. In an embodiment wherein a server includes a context identifier, the server may provide an option for a client to add and/or edit the context of a message.

In accordance with the present system, the context identifier may supply a user interface on a client for operation in accordance with the present system. The user interface may include a system to analyze a message for providing suggestions of context to a user and/or for automatically adding the context to a message, for example as metadata associated with the message. The context identifier may enable a user to manually determine and associate context with a message. Other systems for associating the context with the message may be suitably utilized.

In accordance with a further embodiment, the user interface may include a physical interface including one or more of display, activation of suitable selection devices (e.g., input keys) for user selection of the context as well as other elements as may be appreciated by a person of ordinary skill in the art. In accordance with an embodiment, the context identifier and/or another portion of the client and/or server may provide a graphical user interface (GUI) as an environment for manipulating context including adding, viewing, edition, etc. context of the message. To facilitate manipulation of the context, the GUI may provide different views that are directed to different portions of the manipulation process. For example, the GUI may provide a user interface (UI) including a windowing environment and as such, may include menu items that are typical of those provided in a windowing environment, such as may be represented within a Windows™ Operating System GUI as provided by Microsoft Corporation. The objects and sections of the GUI may be navigated utilizing a user input device, such as a mouse, trackball, keyboard and/or other suitable user input. Further, the user input may be utilized for making selections within the GUI, such as by selection of a “radio button” type selection paradigm as understood by a person of ordinary skill in the art, for example to enable selection of a context to be associated with a message. The UI of the context identifier may be integrated together with the UI of a messaging program or may be provided as a stand-alone UI.

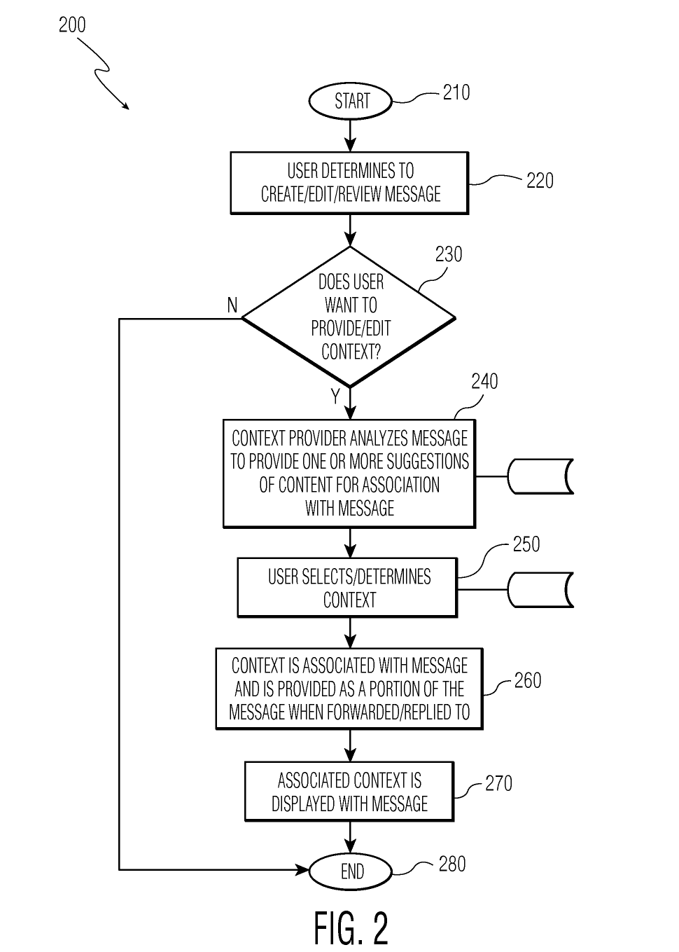

FIG. 2 shows an illustrative flow diagram 200 of operation in accordance with an embodiment of the present system. During act 210, the process may begin. The user may determine to create, review or edit a message during act 220. In accordance with an embodiment, the user may be provided with an option to add and/or edit context for the message during act 230. Should the user decide to not add and/or edit context for the message, the process ends during act 280 and the user may interact with the message including creating, reviewing or editing the message and reviewing any context previously associated with the message after act 280. In accordance with an embodiment, should the user decide to subsequently add and/or edit previously provided context, the process may thereafter be reinitiated, for example, at either of acts 240, 250 as shown.

In a case wherein the user decides to provide and/or edit the context during act 230, the context identifier may analyze the message to provide suggestions of context for association with the message during act 240. During act 250, the user may provide context independent of the context identifier and/or the user may select context suggested by the context identifier. In accordance with an embodiment, the context may be provided to the user as a list of tags. The user interface may enable user selection of one or more of the tags to provide context for the message. In addition or in place of the suggestions provided by the context identifier, the context identifier may merely provide a user interface for adding context to the message in which case, act 240 may be bypassed or deleted.

In any event regardless of how context is provided, the context is associated with the message and is provided together with the message during act 260 should the user choose to manipulate the message including review, reply to, and/or forward the message. The associated context may be stored locally at a client separate or together with the message and/or may be stored centrally with one or more servers, such as the servers shown in FIG. 1. In one embodiment, the message and associated context may be stored as a transcript of messages bearing a same or similar context locally at one or more clients and/or centrally at one or more servers. In a further embodiment, the context and the UI of the context identifier may make available a way for a user to query the system to identify, retrieve and/or review messages and/or message transcripts identified during the querying.

In accordance with the present system, the associated context is displayed together with the message during act 270, for example as a portion of the message such as a suffix, and/or separate from the message, such as in a separate display window as may be readily appreciated by a person of ordinary skill in the art. In one embodiment in accordance with the present system, the context is provided during a mouse-over of a given message, such as when the user manipulates a cursor over or near a given message. Messages that are associated with a same context may be colored similarly wherein the UI provides for variations including color and/or grayscale in the provided text. In this embodiment, messages that are associated with a different context may be provided with different colors.

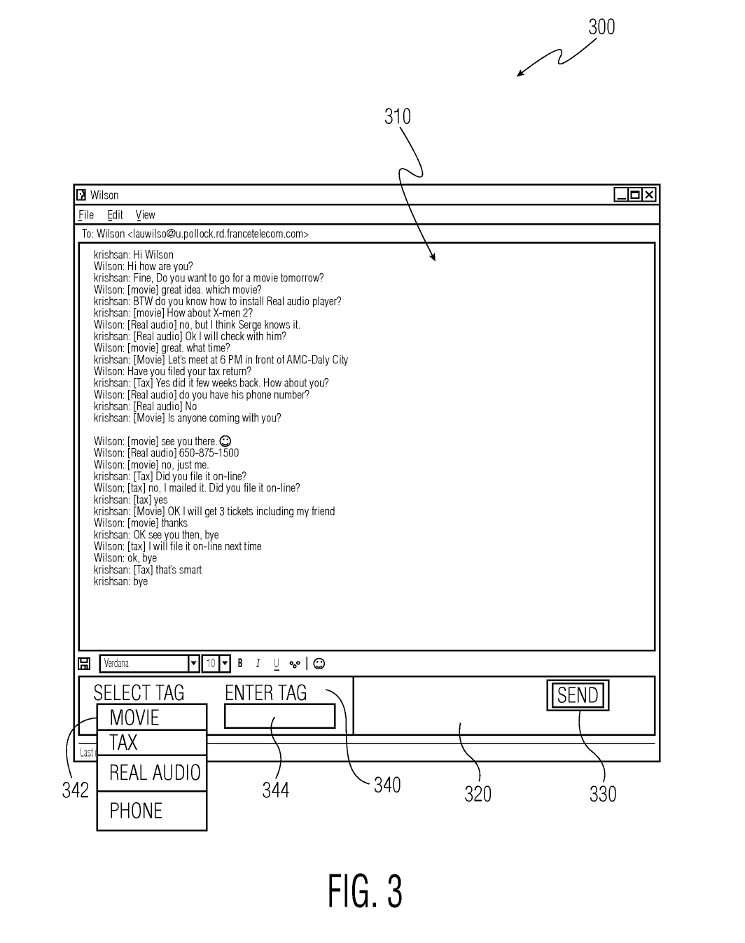

FIG. 3 shows an illustrative display window 300 of an instant messaging system in accordance with an embodiment of the present system. In this embodiment, the display window 300 is made up of three display portions. A display portion 310 shows a running transcript of messages exchanged in an order of the exchange. A display portion 320 provides an area for a user to enter a message, either in response to a previous message or as a new message. A message tagging portion 340 provides an area for a user to select, approve, edit and/or enter a tag for a message, for example in areas 342, 344. Illustratively, the display portion 310 includes a running transcript between two users. In this embodiment, the context identifier adds a context tag in response to noun identification within the message or may simply suggest the context tag in the area 342. The context tag is added, for example as metadata, and maintained until the context identifier identifies a change in the content stream of the messages, at which time, the context identifier provides a different context tag for that message stream. After identification of the context tag, each tag may be maintained and displayed as a prefix for the message stream as received. Illustratively, the context tag may be shown in the line of the message as displayed. In one embodiment, introductory statements and concluding statements of a message stream are identified by the context identifier and are not provided with context tags as illustratively shown.

A user may have an opportunity to respond directly to a given message, such as by clicking on a selection item or menu item within a user interface as would be readily appreciated by a person of ordinary skill in the art. For example, in one embodiment, a click and/or double click on one or more items of a given context tag or message containing the context tag may cause entries in the display portion 320 to be provided associated with a given context tag. In another embodiment, an association of a message with a previously identified context tag may be based on determining or further determining the context of a given message. The message or response to a message may be transferred together with the context tag to a message recipient in response to a user selection , for example, of a send radio button 330.

Following is an illustrative scenario where two or more users (e.g., users A, B & C) are involved in an IM based conversation in accordance with an embodiment of the present system. User A may enter a message in a form of a question on a chat window such as “What movie do you want to see on Friday?” The system, through use of a context provider in accordance with the present system, may during runtime provide one or more context tags that are associated with the message. For example, in the provided example, the context tag may be “Movie” and/or “Friday”. The message is forwarded to one or more intended recipients together with the associated context tag or tags. In an embodiment wherein the context provider is provided in a server, the recipient of the message (question) may have an option to select a suitable context tag provided by the server as “Movie” which then is associated with the message and may be provided in front of a reply message box within a user interface of the system. A reply such as “Yes, we can go for an identified movie” may be provided. Advantageously, all further messages of the message stream may have “Movie” added to their list of tags (e.g., such as in line as a prefix for the further messages) and thereby, the recipients of the message or further messages will know the message or further messages (e.g., responses) are related to the question asked about the movie. Accordingly, even a short reply such as “yes” will be provided in context with the question asked (e.g., “<movie> Yes”). Perhaps, be the time other users reply to this question message, user B might have started a new conversation “Does anyone know how to install the new QuickTime player?” In accordance with an embodiment of the present system, the system (e.g., server and/or client based context provider) may have the intelligence to identify this second unrelated question message as pertaining to a new conversation and provide a different context tag such as “QuickTime” or “Player”. In this way, the new message (question) with the new context tag may be provided to the users to identify the separate message stream.

In one embodiment, context may be inferred by the context provider. For example, a message that states “Let's go see Terminator” may illicit a context tag of “movie”. In this embodiment, the context tag may be based on an identification of the verb “see” and a cross reference to a database that identifies “Terminator” as a movie. Other systems for inferring a context may be suitably applied, such as by a context inferring engine. Naturally, this context tag may be automatically provided associated with the message or the context tag may be merely suggested to a user for association with the message.

The messages may be saved individually as message items associated with identified context tags locally and/or at a message server location. In this way, a user may subsequently (e.g., after a few days) query the system based on the context tags. In an illustrative embodiment, a user (User C) may go to access the system, for example through a message client (e.g., IM client), and select a “View History” option to search for a previous message and/or message stream. A query may be provided based on one or more portions of associated context tags and other associated data, all of which may be associated as metadata with the one or more messages (e.g., the message stream). A query such as based on a specific day (e.g., Apr. 23, 2003) and a given context tag (e.g., Movie) may enable retrieval and viewing of a conversation thread related to “Movie” on that day. A query based solely on the context tag may retrieve messages associated with the specified context tag up to a present time thereby enabling retrieval of an entire message stream (e.g., initial message and all related messages).

In one embodiment, the context tag may be a graphic, symbol and/or other identifiable visual communication. For example, for the above discussion, an icon depicting a picture of a movie camera may be utilized in place of the context identifier “movie”. In one embodiment, the user may be provided an option to select a context identifier, including two or more different types of context identifiers, such as the movie camera icon or “movie” context tag.

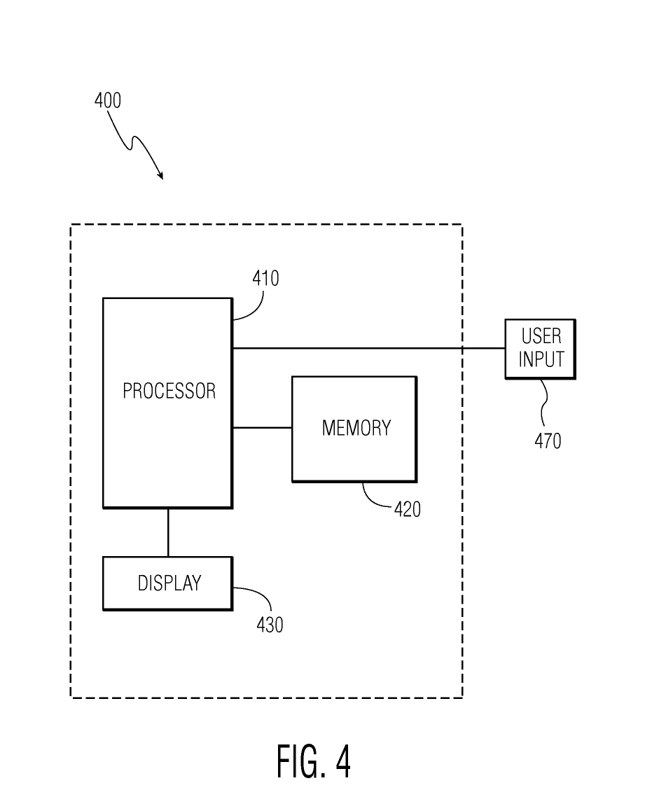

FIG. 4 shows a device 400 in accordance with an embodiment of the present system. The device may be a portion of a client and/or server as described herein. One or more such devices may be resident within the system 400 for operation as described herein. For example, the device 400 may provide operation acts of a context provider at one or more of a client and/or server. The device has a processor 410 operationally coupled to a memory 420, a display 430 and a user input device 470. The memory 420 may be any type of device for storing application data as well as other data, such as context data, message data, etc. The application data and other data are received by the processor 410 for configuring the processor 410 to perform operation acts in accordance with the present system. The operation acts may include operation as a context provider in an embodiment including one or portions of a querying system and controlling the display 430 to display content such as a GUI. The user input 470 may include a keyboard, mouse, trackball or other devices, including touch sensitive display, which may be stand alone or be a part of a system, such as part of a personal computer, personal digital assistant, mobile phone or other display device for communication with the processor 410 via any type of link, such as a wired or wireless link. The user input device 470 is operable for interacting with the processor 410 including enabling interaction within a paradigm of a GUI, identification and/or association of a context tag, and/or other elements of the present system. Clearly the processor 410, memory 420, display 430 and/or user input device 470 may all or partly be a portion of a computer system or other device such as a client and/or server as described above.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 420 or other memory coupled to the processor 410.

The computer-readable medium and/or memory 420 may be any recordable medium (e.g., RAM, ROM, removable memory, CD-ROM, hard drive, DVD, floppy disks and/or memory cards) or may be a transmission medium (e.g., a network comprising fiber-optics, the world-wide web, cables, or a wireless channel using time-division multiple access, code-division multiple access, and/or other radio-frequency channel). Any medium know or developed, or combination thereof, that can store and/or transmit information suitable for use with ac computer system may be used as the computer-readable medium and/or memory 420.

Additional memories may also be used. The computer-readable medium, the memory 420, and/or any other memories may be long-term, short-term 420, or a combination of long-term and short-term memories. These memories configure processor 410 to implement the methods, operational acts, and functions disclosed herein. The memories may be distributed, for example between the clients and/or servers, or local and the processor 410, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessed by a processor. With this definition, information accessible through a network is still within memory 420, for instance, because the processor 410 may retrieve the information from the network for operation in accordance with the present system.

The processor 410 is capable of providing control signals and/or performing operations in response to input signals from the user input device 470 as well as in response to other devices of a network and executing instructions stored in the memory 420. The processor 410 may be an application-specific or general-use integrated circuit(s). Further, the processor 410 may be a dedicated processor for performing in accordance with the present system or may functions operates for performing in accordance with the present system. The performing in accordance with the present system. The processor 410 may operate utilizing a program portion, multiple program segments, or may be a hardware device utilizing a dedicated or multi-purpose integrated circuit.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A processor for a messaging system, the processor comprising:
a portion configured to receive a message;
a portion configured to associate a context tag with the message; and
a portion configured to provide the message with the associated context tag if the message is transferred to a client during a messaging exchange.

2. The processor of claim 1, wherein the processor is configured as a context provider, and wherein the context provider is configured to analyze the message to identify the context tag.

3. The processor of claim 2, wherein the context provider is configured to identify at least one of a noun and verb contained within the message and provide the identified at least one of a noun and verb as the context tag.

4. The processor of claim 1, wherein the processor is configured to provide the context tag automatically without user intervention.

5. The processor of claim 1, wherein the processor is configured to provide at least one context tag for selection by a user.

6. The processor of claim 1, wherein the context tag is a first context tag, wherein the processor is configured to:
identify a topic change within a message stream including the message;
identify a second context tag for a message corresponding to the topic change; and
associate the second context tag with the identified message.

7. The processor of claim 1, wherein the processor is configured to provide the context tag as a prefix of the message during the messaging exchange.

8. The processor of claim 1, wherein the processor is configured to store the message and the associated context tag.

9. The processor of claim 8, wherein the message and associated context tag is one of a plurality of stored messages and corresponding message tags, wherein the processor is configured to:
receive a query;
compare the query to the plurality of associated context tags; and
retrieve a message and associated context tag in response to the comparing.

10. The processor of claim 9, wherein the processor is configured to retrieve a message stream in response to the comparing.

11. The processor of claim 1, wherein the processor comprises a portion of a client system.

12. The processor of claim 1, wherein the processor comprises a portion of a server system.

13. The processor of claim 1, wherein the processor comprises a portion of an instant messaging system.

14. The processor of claim 1, wherein the processor comprises a portion configured to provide a user interface.

15. A method for operation of a messaging system, the method comprising acts of:
receiving a message;
associating a context tag with the message; and
providing the message with the associated context tag if the message is transferred to a client during a messaging exchange.

16. The method of claim 15, comprising an act of analyzing the message to identify the context tag.

17. The method of claim 16, comprising acts of:
providing at least one context tag for selection by a user;
receiving selection of a context tag; and
providing the selected context tag as the context tag.

18. The method of claim 15, wherein the context tag is a first context tag, the method comprising acts of:
identifying a topic change within a message stream including the message;
determining a second context tag for a message corresponding to the topic change; and
associating the second context tag with the identified message.

19. The method of claim 15, comprising an act of providing the context tag as a prefix of the message during the messaging exchange.

20. The method of claim 15, comprising acts of:
storing the message and the associated context tag as one of a plurality of stored messages and corresponding message tags;
receiving a query;
comparing the query to the plurality of associated context tags; and
retrieving a message and associated context tag in response to the comparing act.
